(19) United States
(12) Patent Application Publication
(10) Pub. No.: US 2006/0224475 A1
(43) Pub. Date: Oct. 5, 2006

(54) Method and system for defining data in a transaction

(75) Inventors: Darin John Kramer, Horace, ND (US); Eric David Iverson, Kindred, ND (US); Teresa Ann Backes, West Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/096,937

(22) Filed: Apr. 1, 2005

(51) Int. Cl. G07F 19/00; G06Q 40/00; G07B 17/00

(52) U.S. Cl. 705/30; 705/35

(57) ABSTRACT

A method and system for defining data in a transaction for an accounting system. A data structure includes a transaction category entity defining an area in a business where transactions occur. The data structure also includes a transaction type entity having an association with the transaction category entity and defining a kind of transaction. In addition, the data structure includes a transaction profile entity having an association with the transaction type entity and having properties which define rules for handling the transaction.

### BACKGROUND OF THE INVENTION

The present invention generally relates to computerized financial and/or accounting systems. More particularly, the present invention relates to defining data in a transaction for a financial and/or accounting system.

Computerized financial systems and programs (i.e., software applications) are configured for use by both accountants and non-accountants. These systems allow for configuration of various accounts such as general ledger, inventory, order entry, accounts receivable, accounts payable and payroll accounts. The accounts, or account modules, of the accounting system are typically fully integrated and share common data.

Within each account, or account module, transactions occur and the accounting system performs the necessary credit and debits of the affected account including posting the transaction to the general ledger without requiring the user to enter in more data. Such computerized accounting systems are ideal tools for the non-accountant user. Additionally, they save time, reduce likelihood of errors and eliminate the need to reenter data for both the non-accountant and accountant user.

Each transaction within the accounting system has a transaction type. A transaction type is a kind of transaction. Example transaction types include an invoice, a credit memo, a debit memo, and a return. Each transaction type within the accounting system has a transaction category. A transaction category is an area within a business where transactions occur. Example transaction categories include accounts payable, accounts receivable and general ledger. In one example, an invoice transaction type can belong to an accounts receivable transaction category. While, in another example the invoice transaction type can belong to an accounts payable transaction category. These two transactions are both invoices but they have separate purposes and flow through the accounting system differently depending on the transaction category to which each of the transactions belong.

As is well known, many of today's businesses utilize many modes of pushing transactions. For example, a single business could be processing transactions completed over the Internet as well as processing transactions completed through traditional customer service entry. A particular transaction can occur under a certain transaction category, such as accounts receivable, and a certain transaction type, such as invoice. However the transaction type (invoice) should look and act differently if it occurs as an Internet transaction versus a traditional customer service transaction. Currently, accounting systems predefine transaction types to function in a certain way. To configure an accounting system to process a transaction in different ways (i.e. Internet transactions, customer service transactions) takes a great deal of customization and, therefore, cost and complexity. Typically, users of an accounting system, due to its complexity, are not able to customize different ways in which a transaction can behave.

### SUMMARY OF THE INVENTION

The present invention provides a method and system for defining data in a transaction for an accounting system. The system includes a data structure having a transaction category entity defining an area in a business where transactions occur. The data structure also includes a transaction type entity having an association with the transaction category entity and defining a kind of transaction. In addition, the data structure includes a transaction profile entity having an association with the transaction type entity and having properties which define rules for handling the transaction.

The method of forming a data structure includes defining a transaction category entity as an area in a business where transactions occur and defining a transaction type entity having an association with the transaction category as a kind of transaction. The method also includes defining a transaction profile entity having an association with the transaction type entity and having properties which define rules for handling the transaction. The transaction profile entity is then selected.

### BRIEF DESCRIPTION OF THE DRAWINGS

FIG. 1 illustrates a block diagram of a general computing environment in which the present invention can be practiced.

FIG. 2 is a block diagram illustrating a data structure in accordance with an embodiment of the present invention.

FIG. 3 is a table illustrating example transaction category entities, transaction type entities and transaction profile entities in accordance with an embodiment of the present invention.

FIG. 4 is a block diagram illustrating a specific example of association to a single transaction category entity.

FIG. 5 is a flowchart illustrating a method of forming a data structure in accordance with an embodiment of the present invention.

FIG. 6 illustrates a data structure in accordance with an embodiment of the present invention.

FIG. 7 illustrates an example data structure in accordance with an embodiment of the present invention.

### DETAILED DESCRIPTION OF ILLUSTRATIVE EMBODIMENTS

The present invention is described in the context of a computer-readable medium having stored thereon a data structure for defining data in a transaction for financial and/or accounting systems. Before describing aspects of the present invention, however, it may be useful to describe suitable computing environments that can incorporate and benefit from these aspects.

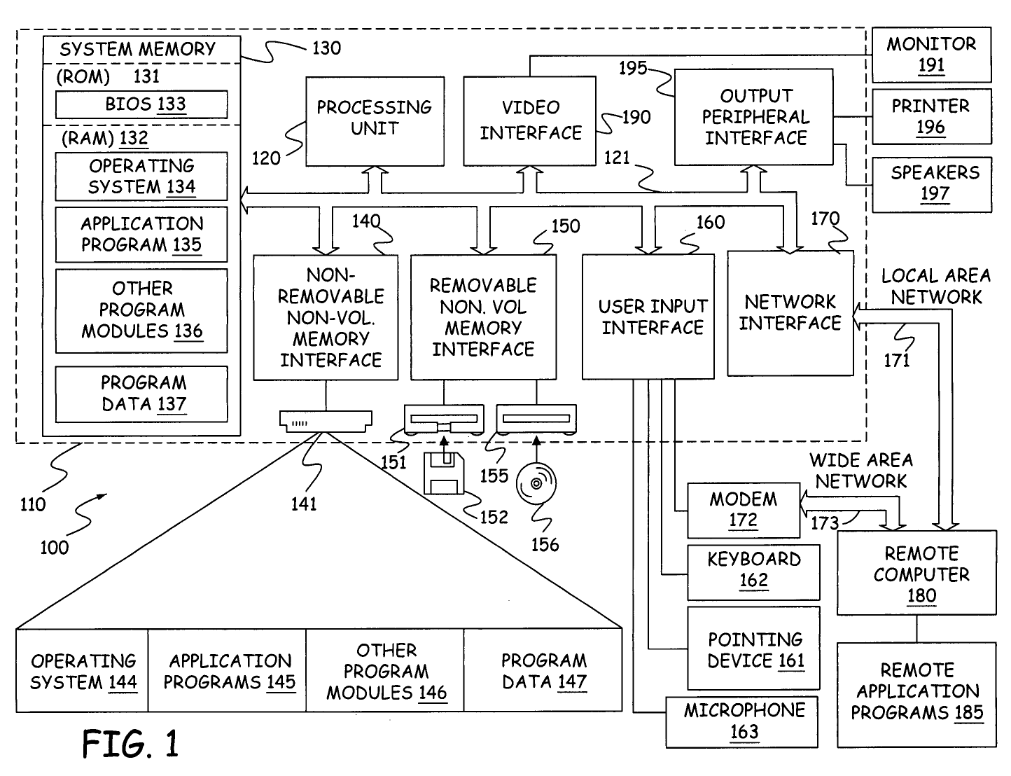

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communication network. In a distributed computing environment, program modules may be located in both local and remote computer storage media including memory storage devices. Tasks performed by the programs and modules are described below and with the aid of figures. Those skilled in the art can implement the description and figures provided herein as processor executable instructions, which can be written on any form of a computer readable medium.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

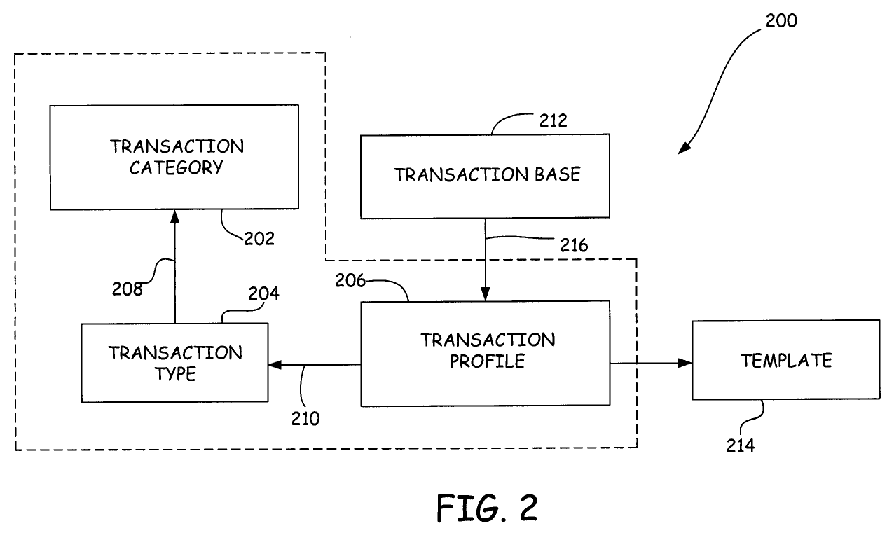

FIG. 2 is a block diagram illustrating a data structure 200 in accordance with an embodiment of the present invention. Data structure 200 defines data in a transaction for financial and/or accounting systems. A transaction is an event or conduction of business that occurs between two parties, such as between a customer and a supplier. A transaction can also be an event that occurs internal to the accounting system, such as adjustments to a general ledger or depreciation. For example, a transaction can be recorded on a document to thereby describe the event and describe how a particular transaction should behave. In accordance with embodiments of the present invention, it is desirable to organize transactions into some sort of classification and ordered structure such that each transaction is tracked, each transaction includes a certain look and feel and each transaction conveys certain information.

Accounting or financial systems commonly use entity relationship databases for modeling data, such as entity relationship databases that use UML (unified modeling language). An entity is a relational database data structure which manages data. The entity preserves its internal data and the integrity of its relationships with other entities. Data of the entity is defined through its properties. In addition, entities use associations to describe relationships between entities.

As illustrated in FIG. 2, data structure 200 includes a transaction category entity 202, a transaction type entity 204 and a transaction profile entity 206. Transaction category entity 202 defines an area in a business where a transaction can occur. Example transaction category entities include accounts payable, accounts receivable, payments, receipts, bank deposit and general ledger. Those skilled in the art will recognize that these examples are not an exhaustive list of example transaction category entities. Other transaction category entities are possible.

Transaction type entity 204 defines a particular kind of transaction. Example transaction type entities for an account payable transaction category entity include invoice, credit memo and return. Those skilled in the art will recognize that these example transaction type entities are not an exhaustive list for an accounts payable transaction category entity. In addition, other transaction category entities, besides an accounts payable transaction category entity, can include different example transaction type entities.

Although a transaction category entity can have many associated transaction type entities, a transaction type entity has an association with only a single transaction category entity. As illustrated, transaction type entity 204 has an association, as indicated by arrow 208, with transaction category entity 202.

Transaction profile entity 206 is used to drive the functions of a transaction and allow for a user to define rules for handling of a transaction. An invoice transaction entity type can have various ways in which it looks, feels and acts within a financial and/or accounting system depending on the different ways that a particular business pushes transactions. Transaction profile entities further define the different ways that a transaction can function. For example, a business can provide different ways of invoicing a customer purchase based on how the product was purchased. The business can provide an Internet web site, provide standard customer service order entry and provide special orders that are completed by salespeople in the field. These examples are not an exhaustive list of ways a business can provide invoicing to a customer. Regardless, each way of defining a transaction type entity is further defined by a transaction profile entity.

Although transaction type entities can have many associated transaction profile entities, a transaction profile entity has an association with only a single transaction type entity. As illustrated, transaction profile entity 206 has an association, as indicated by arrow 210, with transaction type entity 204.

Data structure 200 also includes a transaction base entity 212 and an optional transaction template entity 214. Transaction base entity 212 represents the creation of a transaction or the actual transaction event between two parties. Although transaction profile entities can have many associated transaction base entities, a transaction base entity has an association with only a single transaction profile entity. As illustrated, transaction base entity 212 has an association, as indicated by arrow 216, with transaction profile entity 206. In addition, transaction profile entity 206 can also optionally have an association with a transaction template entity 214. Transaction template entity 214 is configured to populate transaction base entity 212 with a set of default properties and is associated with transaction profile entity 206. For example, an invoice transaction type entity having an Internet website transaction base entity 212 can be associated with a transaction template entity. The transaction template entity populates the website transaction profile entity with information related to a location where inventory should be retrieved. However, it should be noted, that transaction profile entity 206 need not be associated with transaction template entity 214. Transaction profile entity 206 can operate without an associated transaction template entity.

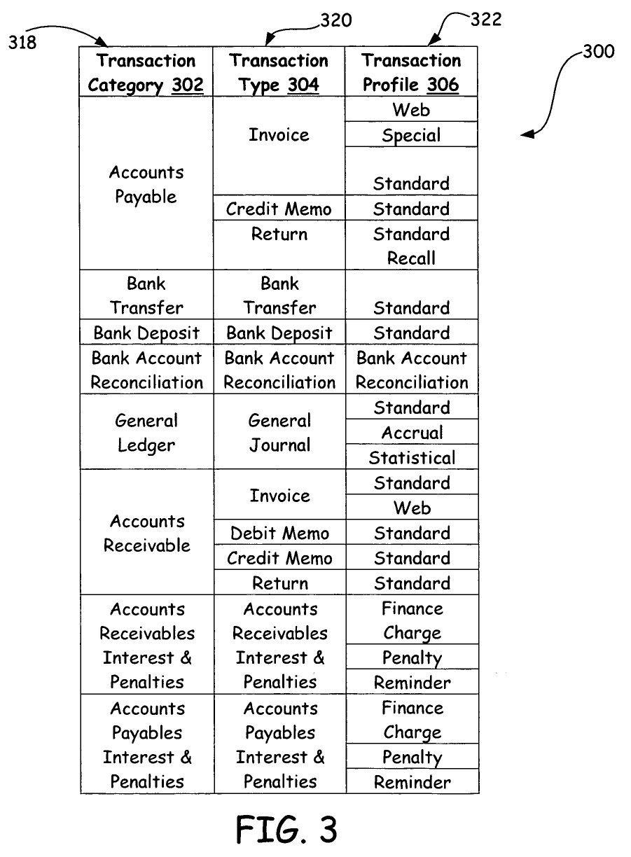

FIG. 3 is a table 300 illustrating example transaction category entities, example transaction type entities and example transaction profile entities in accordance with the present invention. A first column 318 lists example transaction category entities 302. Examples include accounts payable, bank transfer, bank deposit, bank account reconciliation, general ledger, accounts receivable, accounts receivable interest and penalties and account payable interest and penalties.

A second column 320 lists example transaction type entities 304. Each of the example transaction type entities 304 is illustrated as being associated with a single transaction category entity. In one example, an invoice, a credit memo and a return type of transaction type entities 304 are each associated with the accounts payable transaction category. In another example, a general journal of transaction type is associated with the general ledger transaction category.

A third column 322 lists example transaction profile entities 306. Each of the example transaction profile entities 306 is illustrated as being associated with a single transaction type entity. In one example, a web, a special and a standard profile of transaction profile entities 306 are each associated with an invoice transaction type, which, in turn, is associated with the accounts payable transaction category. In another example, a standard, an accrual and a statistical profile of the transaction profile entities 306 are each associated with a general journal transaction type, which, in turn is associated with the general ledger transaction category.

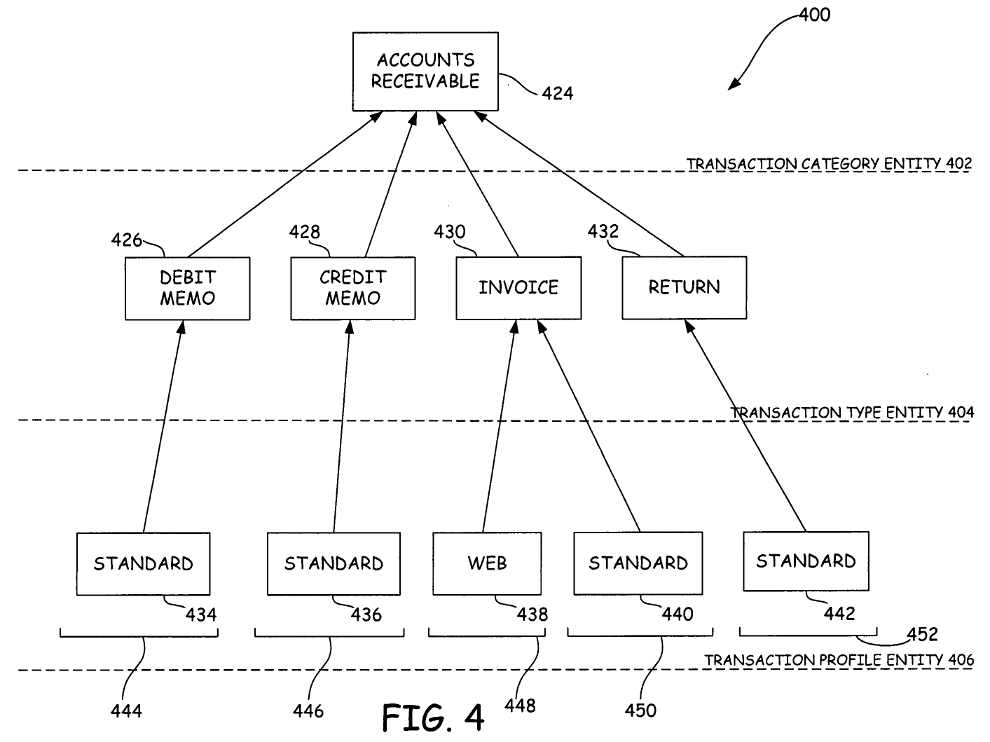

FIG. 4 is block diagram 400 illustrating a specific example of associations to a single category of a plurality of transaction category entities 402. In FIG. 4, the single transaction category entity 402 is an accounts receivable category 424. A select amount of transaction type entities 404 are associated with the accounts receivable category 424. The select types include a debit memo type 426, a credit memo type 428, an invoice type 430 and a return type 432. A select amount of transaction profile entities 406 are associated with each of the select transaction type entities. The select profiles include a standard profile 434 associated with the debit memo type 426, a standard profile 436 associated with the credit memo type 428, a web profile 438 associated with an invoice type 430, a standard profile 440 associated with the invoice type and a standard profile 442 associated with a return type 432.

As illustrated in FIG. 4, accounts receivable category 424 belongs to a plurality of different data structures that define data in a transaction. Each data structure describes a set of associations to account receivable category 424. In addition to account receivable category 424 belonging to a plurality of different data structures, each transaction entity type of the transaction type entities 404 can also belong to different data structures. However, each profile of transaction profile entities 406 belongs to a single data structure.

The following are descriptions of each data structure illustrated in FIG. 4. First data structure 444 includes standard profile 434 associated with debit memo type 426 which is associated with account receivable category 424. Second data structure 446 includes standard profile 436 associated with credit memo type 428 which is associated with account receivable category 424. Third data structure 448 includes web profile 438 associated with invoice type 430 which is associated with account receivable category 424. Fourth data structure 450 includes standard profile 440 associated with invoice type 430 which is associated with account receivable category 424. Fifth data structure 452 includes standard profile 442 associated with return type 432 which is associated with account receivable category 424.

Therefore, FIG. 4 illustrates that accounts receivable category 424 is included in all five different data structures. FIG. 4 also illustrates that invoice type 430 is included in two different data structures. The remaining transaction types of the transaction type entity 404 are included in single data structures.

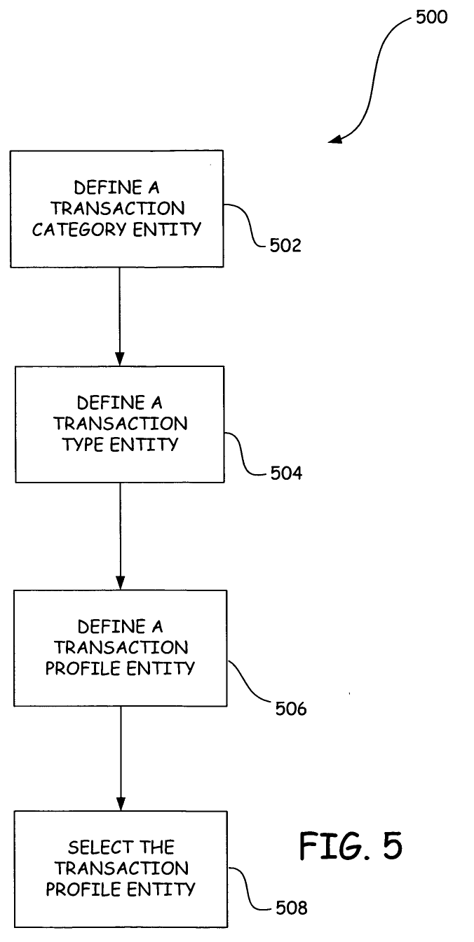

FIG. 5 is a flowchart 500 illustrating a computer implemented method of forming a data structure in accordance with an embodiment of the present invention. At block 502, a transaction category entity is defined as an area in a business where transactions occur. At block 504, a transaction type entity is defined as a kind of transaction that has an association with the transaction category entity. At block 506, a transaction profile entity is defined with rules for handling transactions and has an association with the transaction type entity. At block 508, the transaction profile entity is selected which has properties that define rules for handling transactions and is associated with the transaction type entity.

At block 508, selecting a transaction profile entity includes selecting a transaction profile entity from a plurality of possible transaction profile entities. Each transaction profile entity corresponds with a single data structure. In addition, selecting a transaction profile entity also includes creating or deleting a transaction profile entity and modifying the behaviors or rules of a defined transaction profile entity.

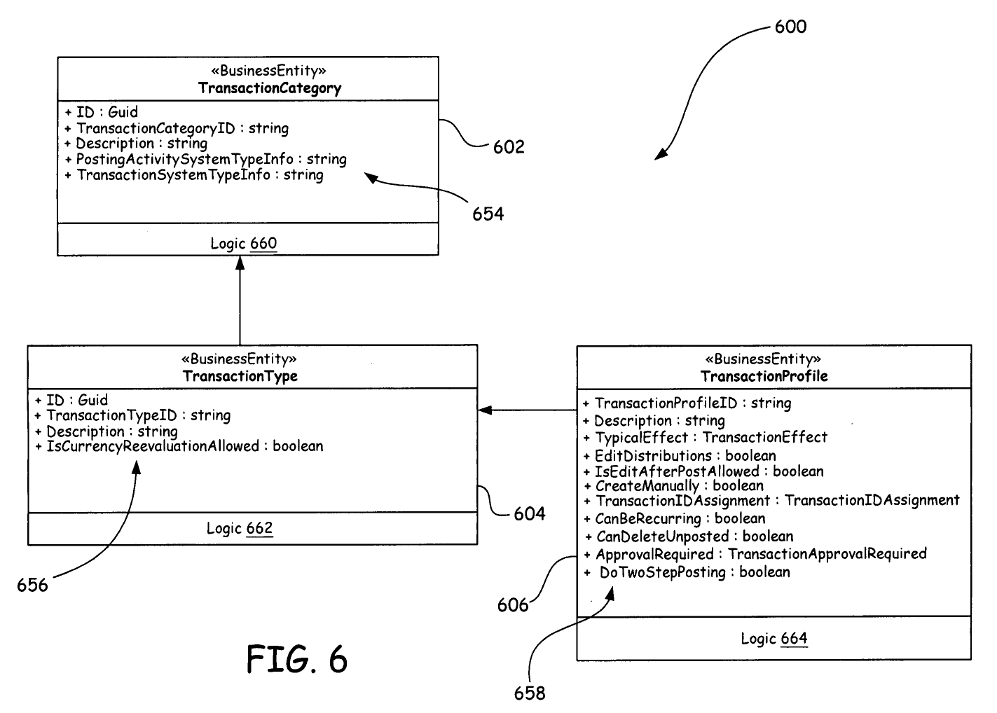

FIG. 6 illustrates a data structure 600 in accordance with an embodiment of the present invention. Data structure 600 includes transaction category entity 602, transaction type entity 604 and transaction profile entity 606. In accordance with an embodiment of the present invention, each entity 602, 604 and 606 has properties that include a set of attributes 654, 656 and 658 and a set of logic 660, 662 and 664 for use in defining each entity. Each of the sets of attributes 654, 656 and 658 include information or properties that define rules and functions related to that particular entity 602, 604 and 606. Each of the sets of logic 660, 662 and 664 include the methods or behaviors of an entity in an accounting and/or financial system. For example, if an entity is either an accounts payable transaction category or an entity associated with an accounts payable transaction category, than a corresponding set of logic includes methods related to cash leaving a business. In another example, if an entity is either an accounts receivable transaction category or an entity associated with an accounts receivable transaction category, than a corresponding set of logic includes methods related to cash entering a business.

The set of attributes 654 and set of logic 660 for transaction category entity 602 are predefined and not accessible by a user. Although the set of attributes 654 and the set of logic 660 are not exposed to users of the accounting system, software developers, such as Independent Software Vendors (ISVs), can integrate with transaction category entity 602 and thereby be exposed to the set of attributes and the set of logic. For example, data fields in the set of attributes 654 for transaction category entity 602 can include a category identification (ID), a description of the category, posting activity system type information and transaction system type information. These are not an exhaustive list of attributes. Other attributes are possible. For example, data fields in the set of attributes 654 can specifically include reference to which transaction types and transaction profiles are associated with transaction category entity 602.

The set of attributes 656 and the set of logic 662 for transaction type entity 604 are predefined, yet exposed to a user for limited manipulation. The user is unable to create and delete transaction type entities, but a user can modify some attributes of a transaction type entity. Although the set of attributes 656 and the set of logic 662 are limitedly exposed to users of the accounting system, software developers, such as ISVs, integrate transaction type entities and thereby have limitless exposure to the set of attributes and the set of logic. An example set of attributes 656 for transaction type entity 604 can include a type identification (ID), a transaction type identification, a description of the type and whether currency reevaluation is allowed. These are not an exhaustive list of attributes. Other attributes are possible. For example, data fields in the set of attributes 656 can specifically include reference to which transaction profiles that are associated with transaction type entity 604.

The set of attributes 658 and the set of logic 664 for transaction profile entity 606 are predefined, yet exposed to users of accounting systems and ISVs for complete modification and deletion. In addition, the user is able to create an unlimited amount of new transaction profiles. Such functionality of the transaction profile entity allows the user to tailor the transaction profiles for specific business purposes and to fit the user's accounting and financial needs. An example set of attributes 658 for transaction profile entity 606 can include a transaction profile identification, a description of the profile, the effect of the transaction to which the profile corresponds, editable distributions, allowing a transaction to be edited after posting, manual creation, transaction identification assignment, allowing the transaction to be recurring, ability to delete un-posted transactions, requiring approval of a transaction, and requiring a two step posting. These are not an exhaustive list of attributes. Other attributes are possible.

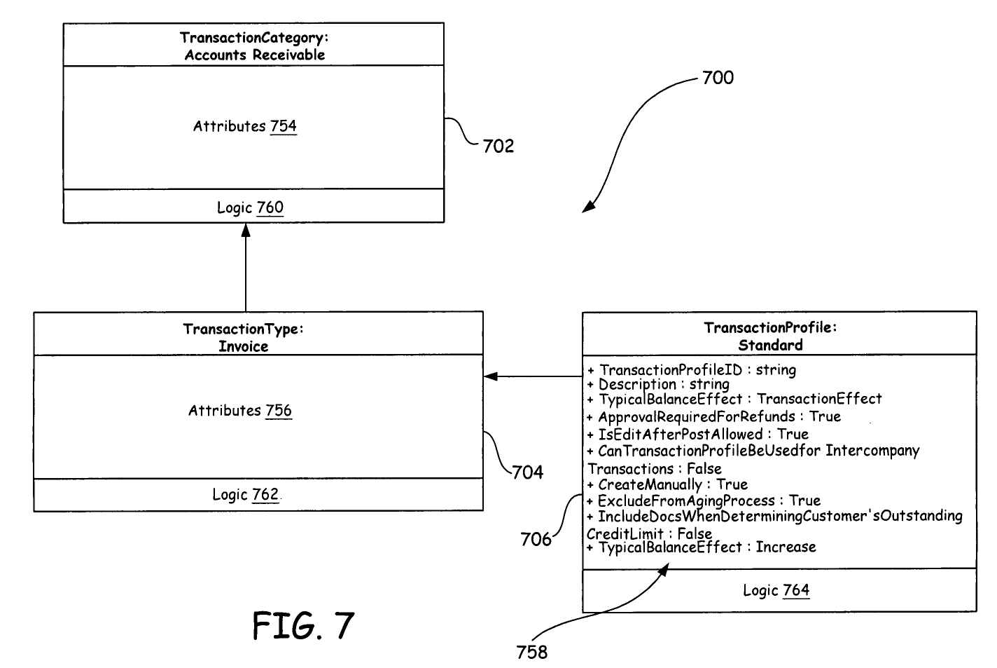

FIG. 7 illustrates a specific example of a data structure 700 in accordance with an embodiment of the present invention. In FIG. 7, data structure 700 includes an accounts receivable transaction category entity 702, an invoice transaction type entity 704 and a standard transaction profile entity 706. Each of the entities include attributes 754, 756 and 758 and logic 760, 762 and 764. An example set of attributes or attribute fields for the standard transaction profile entity 706 include a transaction profile identification, a description of the profile and the effect of the transaction to which the profile corresponds. Other attribute fields within the set of attributes 758 require approval for refunds, allow the editing of the posted transaction, the transaction profile can not be used for inter-business transactions, the transaction can be created manually, the transaction is excluded from the aging process, the transaction does not include documents when determining a customer's outstanding credit limit and the transaction is set to increase the customer's balance. These are not an exhaustive list of attribute fields that can be included in a standard profile for an invoice in the transaction category of accounts receivable. Other attribute fields are possible. In addition, the set of attributes 758 are exposed to the user for deletion, creation and modification of any of the existing attribute fields.

In accordance with the present invention, adding transaction profile entities to a data structure for defining transactions provides the user with a way to manipulate the behavior of any particular type of transaction. A user can create and delete transaction profile entities and can further modify attributes of existing transaction profile entities. The ease of user customization in the present invention is advantageous over transactions in accounting systems that require highly complex customization.

Although the present invention has been described with reference to particular embodiments, workers skilled in the art will recognize that changes may be made in form and detail without departing from the spirit and scope of the invention.

What is claimed is:

1. A computer-readable medium having stored thereon a data structure for defining data in a transaction for an accounting system comprising:
a transaction category entity defining an area in a business where transactions occur;
a transaction type entity having an association with the transaction category entity and defining a kind of transaction; and
a transaction profile entity having an association with the transaction type entity and having properties which define rules for handling the transaction.

2. The apparatus of claim 1, wherein the transaction profile entity is used in a single data structure to define a single transaction.

3. The apparatus of claim 1, wherein the transaction profile entity is a selected one of a plurality of possible transaction profile entities that are in association with the transaction type entity, wherein each of the plurality of possible transaction profile entities are used to define different data structures and thereby different transactions.

4. The apparatus of claim 1, wherein the transaction type entity is used in a plurality of different data structures to define different transactions.

5. The apparatus of claim 1, wherein the transaction type entity is a selected one of a plurality of possible transaction type entities that are in association with the transaction category entity, wherein each of the plurality of possible transaction type entities are used with combinations of transaction type entities and transaction profile entities to define different data structures and thereby different transactions.

6. The apparatus of claim 1, wherein the transaction category entity is used in a plurality of different data structures to define different transactions.

7. The apparatus of claim 1, wherein the transaction category entity is a selected one of a plurality of possible transaction category entities, wherein each of the plurality of possible transaction category entities are used with combinations of transaction type entities and transaction profile entities to define different data structures and thereby different transactions.

8. The apparatus of claim 1, wherein the properties in the transaction profile entity comprise a set of attributes and a set of logic, wherein the logic is configured to manipulate behaviors of the transaction.

9. The apparatus of claim 1 and further comprising:
a transaction base entity having an association with the transaction profile entity; and
a transaction template entity having an association with the transaction profile entity, wherein the transaction template entity is configured to populate the transaction base entity with a set of default properties.

10. The apparatus of claim 1, wherein the transaction profile entity is accessible by a user for modification.

11. The apparatus of claim 1, wherein the transaction category entity is inaccessible by a user for modification.

12. The apparatus of claim 1, wherein the transaction type entity is limitedly accessible by a user for modification.

13. A computer-implemented method of forming a data structure for defining data of a transaction entity in an accounting system, the method comprising:
defining a transaction category entity as an area in a business where transactions occur;
defining a transaction type entity having an association with the transaction category as a kind of transaction;
defining a transaction profile entity having an association with the transaction type entity and having properties which define rules for handling the transaction; and
selecting the transaction profile entity.

14. The computer-implemented method of claim 13, wherein selecting a transaction profile entity comprises creating a transaction profile entity.

15. The computer-implemented method of claim 13, wherein selecting a transaction profile entity comprises modifying the transaction profile entity.

16. The computer-implemented method of claim 13, wherein selecting the transaction profile entity comprises selecting one of a plurality of possible transaction profile entities, wherein each of the possible transaction profile entities are used to define different data structures and thereby different transactions.

17. The computer-implemented method of claim 12, wherein selecting the transaction profile entity comprises selecting the transaction profile entity for a single data structure defining a single transaction.

18. A computer-readable medium having stored thereon a data structure for defining data in a transaction for an accounting system, the computer-readable medium performing the steps of:
defining a transaction category entity as an area in a business where transactions occur;
defining a transaction type entity having an association with the transaction category as a kind of transaction;
defining a transaction profile entity having an association with the transaction type entity and having properties which define rules for handling the transaction
selecting the transaction profile entity.

19. The apparatus of claim 18, wherein the step of defining a transaction profile entity is accomplished by a user.

20. The apparatus of claim 18, wherein the step of defining a transaction type entity is limitedly modifiable by a user.
